(19) United States
(12) Patent Application Publication
(10) Pub. No.: US 2006/0242421 A1
(43) Pub. Date: Oct. 26, 2006

(54) Logon system for an electronic device

(75) Inventor: Ho-Hsiung Hsu, Taipei County (TW)

Correspondence Address: BACON & THOMAS, PLLC, 625 SLATERS LANE, FOURTH FLOOR, ALEXANDRIA, VA, 22314, US

(73) Assignee: Kinpo Electronics, Inc., Taipei (TW)

(21) Appl. No.: 11/139,646

(22) Filed: May 31, 2005

(30) Foreign Application Priority Data
Apr. 26, 2005 (CN) 200510066656.4

(51) Int. Cl. G06F 12/14; H04L 9/00; G06F 17/30; H04K 1/00; G06F 12/00; G06F 13/00; G06F 7/04; G06F 7/58; G06K 19/00; G11C 7/00; H04L 9/32

(52) U.S. Cl. 713/182; 726/17

(57) ABSTRACT

A logon system for an electronic device is provided. The system includes an electronic device and a touch display. The touch display is connected to the electronic device for functioning as an input/output device of the electronic device. For a logon to the electronic device, the electronic device displays a keypad having multiple keys on the touch display, and an arrangement of the keys is determined by the electronic device in random, so that a user can log on the electronic device by touching the keys displayed on the touch display.

### BACKGROUND OF THE INVENTION

1. Field of the Invention

The invention relates to a logon system for an electronic device.

2. Description of Related Art

For a traditional logon of an electronic device such as a computer, terminal, automatic teller machine or entrance guard, as shown in FIG. 1, a password is initially input through a 11 Keys's keypad and the key-in password will then be shown as asterisks on the respective devices' screens. However, this act may lead the user's finger prints remain on the keypad and eventually provides a trace for the password breaking. A classic password crack would be simply uncovering by a finger prints scan.

In addition, when the password is input through a Trojan horse or Key-logging infected computer and which is also connected with an unsecured network, a genuine password will be at the great risk of interception or replicating. Of course, this situation only happens if the computer is virus infected. A known Trojan-horse, Key-logging, and other cracking program have been reported repeatedly to be devastating and cost million and million dollars for today individuals and corporations. Therefore, it is desirable to pursue a new technological breakthrough to minimize the potential password cracking between the end user and the public network.

### SUMMARY OF THE INVENTION

The object of the invention is to provide an unconventional logon system in term of software and hardware which prevents a user password's to be cracked, intercepted and replicated through the public network.

According to the feature that mentioned earlier, a new logon system is consisted of a software and hardware implementation. For the hardware part, a touch display keypad is introduced and which connected with the specific terminal. On the software side, a special program will be working as follow. For a new logon, a touch display keypad is programmed to show a random arrangement of digit from 0 to 9, and the user will be keying the password on the touch display's different areas which are determined by the program of its random digit arrangement. In this way, a traditional key-logging typed cracking will not be sufficient enough to uncover the exact combination of user's password. For every time logon, the system will be provided different digit arrangement for the user and it also minimizes the risk of password perking from ones' back.

There is another equally important feature of the invention is that a new touch display screen design has to been integrated a secured electronic device which provided the security programming. An unbreakable and encrypted electronic design is essentially to the invention. For logon to the electronic device, the electronic device displays a keypad having multiple keys on the display, and an arrangement of the keys is determined by the electronic device in random, so that a user can log on the electronic device by touching the keys displayed on the touch display.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of an input device of keyboard for a typical entrance guard;

FIG. 2 is a diagram of a configuration of a logon system for an electronic device according to the invention;

FIG. 3 is a diagram of a display frame of a display according to the invention;

FIG. 4 is a diagram of a key arrangement of a set of keys displayed on a display according to the invention;

FIG. 5 is a diagram of a random arrangement of a set of keys displayed on a display according to the invention; and

FIG. 6 is a diagram of another random arrangement of a set of keys displayed on a display according to the invention.

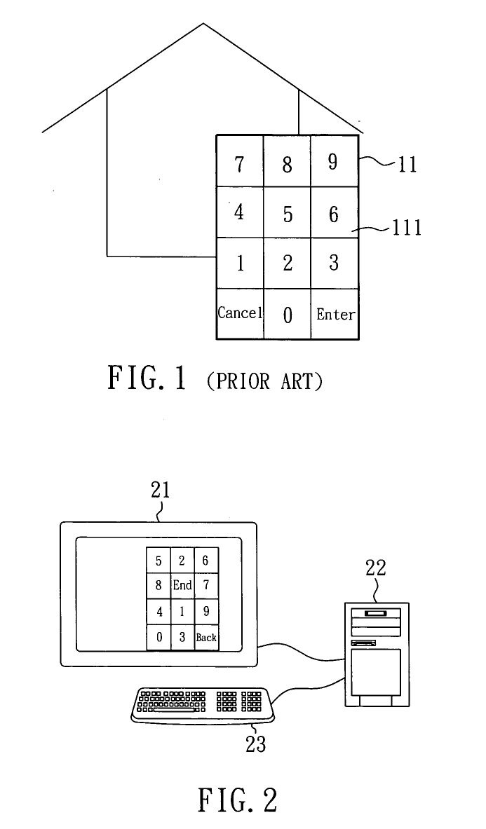

### DETAILED DESCRIPTION OF THE PREFERRED EMBODIMENT

FIG. 2 is a diagram of a configuration of a logon system for an electronic device according to the invention. The system has an input device 23, a display 21 and an electronic device 22. The input device 23 can be a keyboard or mouse to control cursor positions displayed on the display 21 and to input the information of digits or characters to the electronic device 22. The display 21 is an LCD, CRT or touch display connected to the electronic device 22 and can function as an input and output device of the electronic device 22. Namely, the electronic device 22 can display information on the display 21, and when the touch display is used, a user can touch the touch display to input the information to the electronic device 22.

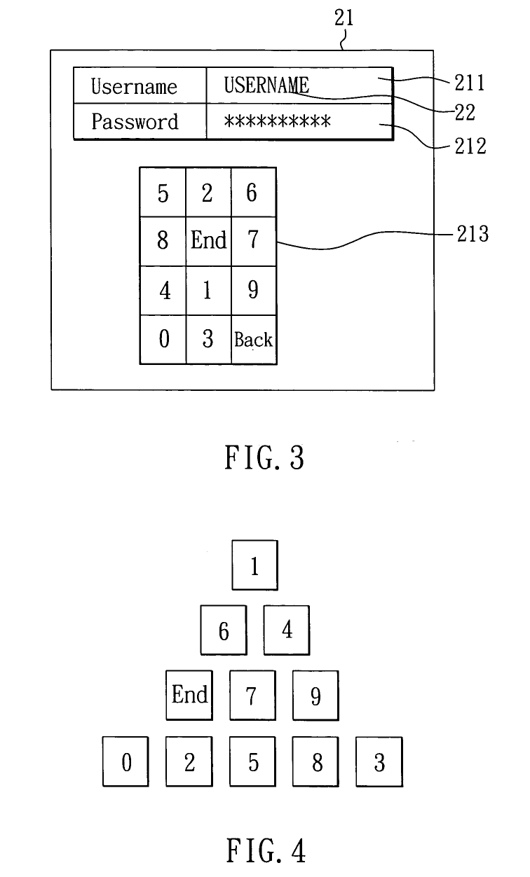

As shown in FIG. 3, when the user is to log on the electronic device 22, the electronic device 22 displays a username field 211 and a password field 212 on the display 21 and presents an input cursor 22 at the username field 211. The user first uses the keyboard 23 to input the username into the username field 211 and then to move the cursor 22 to the password field 212. At this point, the electronic device 22 immediately displays a keypad 213 having multiple keys 2131 on the display 21 automatically, and an arrangement of keys 2131 of the keypad 213 is determined by the electronic device 22 in random. The keypad 213 can be a digit or character keypad, and has an end key ‘End’ and a restore key ‘Back’. In this embodiment, the keypad 213 is a digit keypad, wherein digit keys 0-9 and the keys ‘End’ and ‘Back’ of which are arranged in a matrix. However, the digit keys 0-9 and the keys ‘End’ and ‘Back’ can be arranged in other forms, for example, a triangle, as shown in FIG. 4. Accordingly, the user can use the input device 23 to move the cursor 23 up, down, left and right for clicking the digit keys 0-9 to thus input a password to the electronic device 22. Alternately, when the display 21 is a touch display, the user can directly touch the digit keys 0-9 to input the password to the electronic device 22 and use the restore key ‘Back’ to change the input and the end key ‘End’ to end the input.

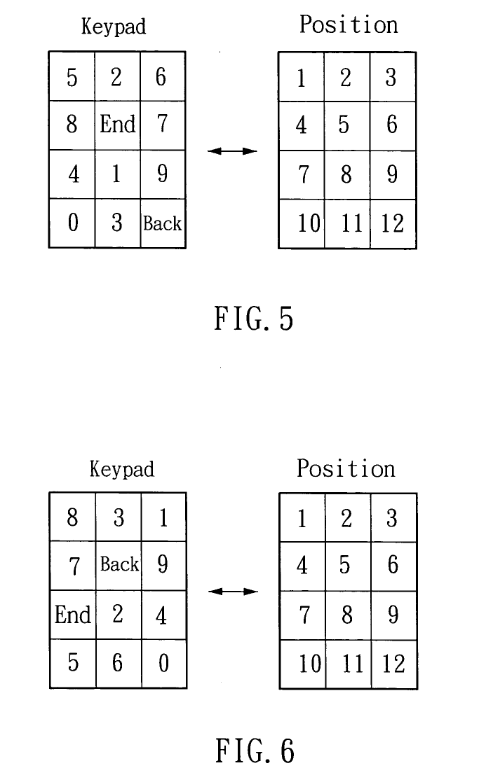

In the logon system for an electronic device, the keys 2131 of the keypad 213 displayed on the display 21 are arranged by the electronic device 22 in random. Thus, the user can have a different arrangement of the keys 2131 displayed at each logon. For example, the keys 0-9 of FIG. 5 correspond to positions (10, 8, 2, 11, 7, 1, 3, 6, 4, 9), but the keys 0-9 of FIG. 6 correspond to positions (12, 3, 8, 2, 9, 10, 11, 4, 1, 6). As such, the password cannot be cracked because the fingerprints are not remained on certain keys of the keypad 213 even the user clicks the identical password each time. In addition, the identical password is input through different position coding, for example, the position coding generated by the password ‘1234’ of FIG. 5 is (10, 8, 2, 11) while the position coding generated by the password ‘1234’ of FIG. 6 is (1, 2, 3, 8, 2). Therefore, a hacker cannot crack the real password, even the password is intercepted in the midway or recorded by a Trojan-horse program.

Further, when the hacker intends to find the password by repeated input, the end key End of the set 213 can be input to end the logon, which can fail to crack the password by repeated input.

As cited, the invention uses a random scheme to determine a display arrangement of the keys on the touch display, such that the keys can be displayed at different positions after the password is input each time. Accordingly, a high security logon system for an electronic device is provided to protect the user password from crack to thus ensure user profits.

Although the present invention has been explained in relation to its preferred embodiment, it is to be understood that many other possible modifications and variations can be made without departing from the spirit and scope of the invention as hereinafter claimed.

What is claimed is:

1. A logon system for an electronic device, comprising:
an electronic device;
a display, connected to the electronic device; and
an input device, to control positions of a cursor displayed on the display and to input information of digits or characters to the electronic device;
wherein for a logon to the electronic device, the electronic device displays a keypad having multiple keys on the display, and an arrangement of the keys is determined by the electronic device in random, so that the cursor is moved through the input device to click the keys for the logon.

2. The logon system as claimed in claim 1, wherein the keypad is a digit keypad.

3. The logon system as claimed in claim 1, wherein the keys are arranged in a matrix.

4. The logon system as claimed in claim 1, wherein the keypad has a restore key to change the information input.

5. The logon system as claimed in claim 1, wherein the keypad has an end key to end inputting the information.

6. A logon system for an electronic device, comprising:
an electronic device; and
a touch display, connected to the electronic device to function as an input and output device of the electronic device, wherein for a logon to the electronic device, the electronic device displays a keypad having multiple keys on the display, and an arrangement of the keys is determined by the electronic device in random, so that the logon is proceed by touching the keys displayed on the touch display.

7. The logon system as claimed in claim 6, wherein the keypad is a digit keypad.

8. The logon system as claimed in claim 6, wherein the keys are arranged in a matrix.

9. The logon system as claimed in claim 6, wherein the keypad has a restore key to change an input.

10. The logon system as claimed in claim 6, wherein the keypad has an end key to end an input.

11. The logon system as claimed in claim 6, further comprising a keyboard to input information of digits or characters to the electronic device.
